(19) United States
(12) Patent Application Publication
(10) Pub. No.: US 2015/0148985 A1
(43) Pub. Date: May 28, 2015

(54) VEHICLE DRIVING ASSISTANCE DEVICE AND AUTOMATIC ACTIVATING METHOD OF VEHICLE DRIVING ASSISTANCE FUNCTION BY THE SAME

(71) Applicant: HYUNDAI MOBIS CO., LTD, Seoul (KR)

(72) Inventor: Jang Hyeon JO, Seongnam-si (KR)

(73) Assignee: HYUNDAI MOBIS CO., LTD., Seoul (KR)

(21) Appl. No.: 14/478,560

(22) Filed: Sep. 5, 2014

(30) Foreign Application Priority Data
Nov. 28, 2013 (KR) 10-2013-0145833

(51) Int. Cl. B60W 30/08; G08G 1/0967; B60W 40/06

(52) U.S. Cl. CPC B60W 30/08; B60W 40/06; G08G 1/096783; G08G 1/096791; G08G 1/096725
USPC 701/1

(57) ABSTRACT

The present invention provides a vehicle driving assistance device, including: a collecting unit which collects vehicle safety information including positional information of a vehicle; a determining unit which determines a kind of driving road on which the vehicle is driven using the positional information; and a control unit which activates at least one driving assistance function related with the kind of driving road, among a plurality of driving assistance functions which is implemented in the vehicle and an automatic activating method of a vehicle driving assistance function by the vehicle driving assistance device.

### CROSS-REFERENCE TO RELATED APPLICATIONS

This application claims priority under 35 U.S.C. §119 to Korean Patent Application No. 10-2013-0145833, filed on Nov. 28, 2013, in the Korean Intellectual Property Office, the disclosure of which is incorporated herein by reference in its entirety.

### TECHNICAL FIELD

The present invention relates to a driving assistance device of a vehicle, and more particularly to a technology which automatically activates a plurality of vehicle driving assistance functions.

### BACKGROUND

Recently, a vehicle driving assistance system which prevents a traffic accident of a driving car in advance and efficiently distributes traffic flow using a vehicle to vehicle (V2V) communication based on a wireless access in vehicular environments (WAVE) and vehicle to infrastructure (V2I) communication has been developed. For example, the vehicle driving assistance system includes technologies related with various traffic safety and convenience services such as an emergency electronic brake light, a forward collision warning system, an intersection collision warning system, an emergency vehicle signal preemption control system, and a multi-lane smart tolling system.

As various driving assistance systems are applied to the vehicle, the vehicle needs to perform lots of tasks (sensor control, various logic control, a warning issuing control, and real-time information processing) at real time. Therefore, this may cause large overload to the system of the vehicle.

### SUMMARY

The present invention has been made in an effort to provide a technical measure which may automatically and selectively activate or inactivate a plurality of driving assistance functions which is implemented in a vehicle depending on a kind of road on which the vehicle drives.

An exemplary embodiment of the present invention provides a vehicle driving assistance device, including: a collecting unit which collects vehicle safety information including positional information of a vehicle; a determining unit which determines a kind of driving road on which the vehicle is driven using the positional information; and a control unit which activates at least one driving assistance function related with the kind of driving road, among a plurality of driving assistance functions which is implemented in the vehicle.

The vehicle driving assistance device may further include a storing unit in which information regarding whether the plurality of driving assistance functions is activated for every kind of road is stored.

The control unit may activate a driving assistance function corresponding to the kind of driving road, among the plurality of driving assistance functions and inactivate other driving assistance functions using the information whether to be activated.

The collecting unit may further collect traffic information from an infrastructure through vehicle to infrastructure (V2I) communication and a control module of the activated driving assistance function may check whether an event occurs, using at least one of the vehicle safety information and the traffic information which are collected by the collecting unit and the control unit may output information of the driving assistance function related with the occurring event when the event occurs.

The collecting unit may further collect other vehicle safety information of another vehicle which is located near the vehicle through vehicle to vehicle (V2V) communication and the control module of the activated driving assistance function may check whether the event occurs, further using the other vehicle safety information.

The control unit may in a state where at least two driving assistance functions are activated among the plurality of driving assistance functions, when two or more events simultaneously occur, output information of the driving assistance function having the highest priority based on the predetermined priority and output at least one information of the warning information and the guidance information in accordance with the driving assistance function which is related with the occurring event.

Another exemplary embodiment of the present invention provides an automatic activating method of a vehicle driving assistance function by a vehicle driving assistance device including: collecting positional information of a vehicle; determining a kind of driving road on which the vehicle is driven using the positional information; and activating at least one driving assistance function related with the kind of driving road, among a plurality of driving assistance functions which is implemented in the vehicle.

The activating may include activating a driving assistance function corresponding to the kind of driving road by reading information on whether to be activated from a memory in which information on whether to activate the plurality of driving assistance functions for every type of the road is stored.

The collecting may include collecting vehicle safety information of the vehicle, traffic information, and safety information of the other vehicle, after the activating, checking whether to an event of the activated driving assistance function occurs, using at least one of the vehicle safety information of the vehicle, traffic information, and safety information of the other vehicle, and outputting information of the driving assistance function related with the vent when the event occurs.

The outputting may include outputting at least one information of the warning information and the guidance information depending on the driving assistance function in which the event occurs and the collecting may include collecting safety information of the host vehicle from a body control module of the vehicle, traffic information from an infrastructure through vehicle to infrastructure (V2I) communication and other vehicle safety information of another vehicle which is located near the vehicle through vehicle to vehicle (V2V) communication.

The outputting includes outputting information on one driving assistance function based on a predetermined priority, when two or more events simultaneously occur, in a state where at least two driving assistance functions are activated among the plurality of driving assistance functions.

According to an exemplary embodiment of the present invention, among a plurality of driving assistance functions which is implemented in a vehicle, driving assistance functions which are activated in accordance with a kind of road are classified in advance to activate some of the driving assistance functions in accordance with the kind of road on which the vehicle is driven and inactivate other functions so that a load (computing and sensing loads) for vehicle driving assistance may be reduced as compared with the vehicle driving assistance technology of the related art and an appropriate function at a right time or right place is operated to reduce an error.

### BRIEF DESCRIPTION OF THE DRAWINGS

FIG. 1 is a block diagram illustrating a vehicle driving assistance device according to an exemplary embodiment of the present invention.

FIG. 2 is a view illustrating a plurality of driving assistance functions which is implemented in a vehicle according to an exemplary embodiment of the present invention.

FIGS. 3A and 3B are a view illustrating an emergency electronic brake light function among a plurality of driving assistance functions which is implemented in a vehicle according to an exemplary embodiment of the present invention.

FIGS. 4A and 4B are a view illustrating an intersection collision prevention warning function among a plurality of driving assistance functions which is implemented in a vehicle according to an exemplary embodiment of the present invention.

FIGS. 5A and 5B are a view illustrating an overtaking warning function among a plurality of driving assistance functions which is implemented in a vehicle according to an exemplary embodiment of the present invention.

FIGS. 6A and 6B are a view illustrating a forward collision warning function among a plurality of driving assistance functions which is implemented in a vehicle according to an exemplary embodiment of the present invention.

FIGS. 7A and 7B are is a view illustrating a blind zone and lane change warning function among a plurality of driving assistance functions which is implemented in a vehicle according to an exemplary embodiment of the present invention.

FIG. 8 is a view illustrating a smart tolling service function among a plurality of driving assistance functions which is implemented in a vehicle according to an exemplary embodiment of the present invention.

FIG. 9 is a view illustrating an emergency vehicle signal preemption function among a plurality of driving assistance functions which is implemented in a vehicle according to an exemplary embodiment of the present invention.

FIG. 10 is a view illustrating information which is provided to a driver after performing any one of a plurality of driving assistance functions according to an exemplary embodiment of the present invention.

FIG. 11 is a flowchart of an automatic activating method of a vehicle driving assistance function by a vehicle driving assistance device according to an exemplary embodiment of the present invention.

FIG. 12 is block diagram illustrating a computer system for implementing the vehicle driving assistance device.

### DETAILED DESCRIPTION OF EMBODIMENTS

Advantages and characteristics of the present invention, and a method of achieving the advantages and characteristics will be clear by referring to exemplary embodiments described below in detail together with the accompanying drawings. However, the present invention is not limited to the exemplary embodiment disclosed herein but will be implemented in various forms. Exemplary embodiments introduced herein are provided to make disclosed contents thorough and complete and sufficiently transfer the spirit of the present invention to those skilled in the art. Therefore, the present invention will be defined by the description of the claims. Meanwhile, terminologies used in the present invention are to explain exemplary embodiments rather than to limit the present invention. Unless particularly stated otherwise in the present specification, a singular form also includes a plural form. The word “comprises” or “comprising” used in the present specification will be understood to imply the inclusion of stated constituents, steps, operations and/or elements but not the exclusion of any other constituents, steps, operations and/or elements.

Hereinafter, exemplary embodiments of the present invention will be described in detail with reference to the accompanying drawings. In the drawings, like components are denoted by like reference numerals if possible even though the components are illustrated in different drawings and when it is judged that specific description on known configurations or functions related in the description of the present invention may unnecessarily obscure the essentials of the present invention, the detailed description will be omitted.

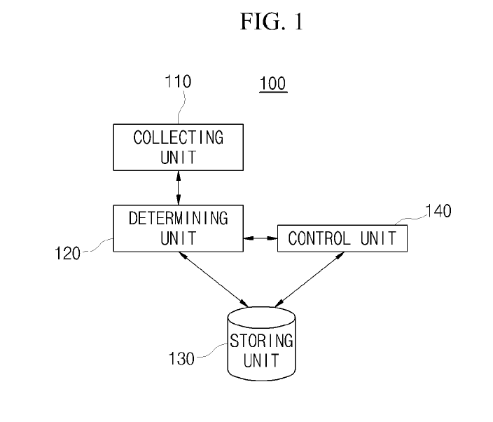

FIG. 1 is a block diagram illustrating a vehicle driving assistance device which automatically activates a vehicle driving assistance function according to an exemplary embodiment of the present invention. A vehicle driving assistance device 100 according to an exemplary embodiment of the present invention classifies, among a plurality of driving assistance functions which is implemented in a vehicle, driving assistance functions which are activated in accordance with a kind of road in advance to activate some of the driving assistance functions in accordance with the kind of road on which the vehicle is driven and inactivate other functions.

Prior to specifically describing an operation of the vehicle driving assistance device 100, the vehicle driving assistance function will be described.

Various driving assistance functions for driving assistance are implemented in a vehicle and the driving assistance functions are provided for safety warning and convenience of a vehicle. Here, the plurality of driving assistance functions may assist the driving of a vehicle using vehicle to vehicle (V2V) communication based on a wireless access in vehicular environments (WAVE) and vehicle to infrastructure (V2I) communication.

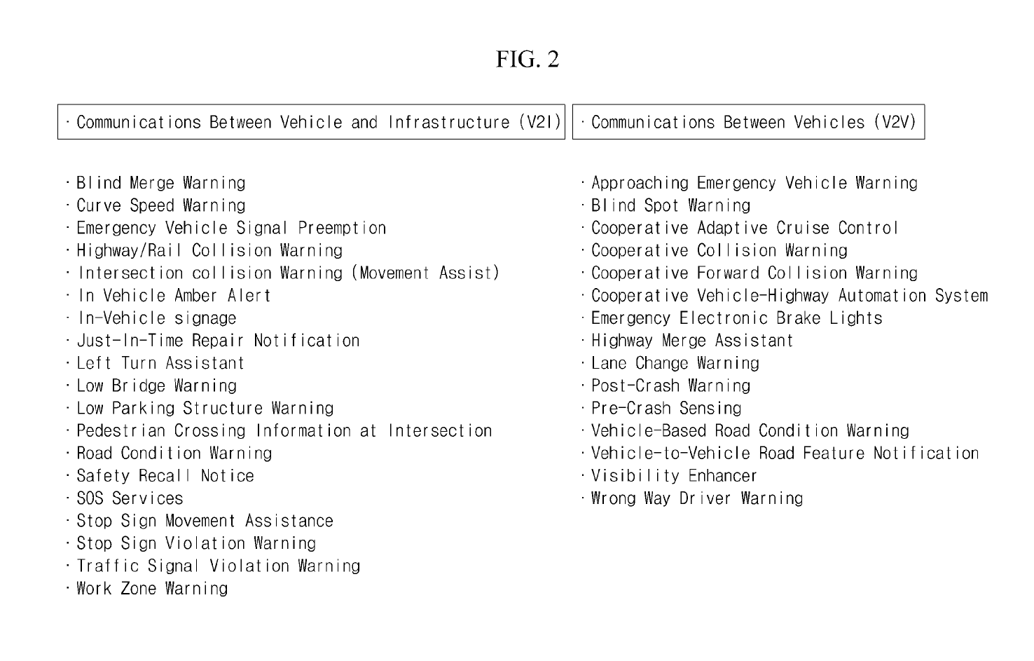

The plurality of driving assistance functions perform an operation of detecting a traffic accident hazard of a vehicle which is being driven to warn the traffic accident hazard to a driver or an operation of providing information for conveniently driving a vehicle. For example, the plurality of driving assistance functions may include an emergency electronic brake light function, an intersection collision prevention warning function, an overtaking warning function, a forward collision warning function, a blind zone and lane change warning function, a smart tolling service function, and an emergency vehicle signal preemption control function. Moreover, the plurality of driving assistance functions may include operations such as a plurality of warnings, guidance, and assistance illustrated in FIG. 2.

The plurality of driving assistance functions may be implemented together in one control module. Alternatively, the plurality of driving assistance functions may be implemented as separate control modules for every driving assistance function. In the exemplary embodiment, it is described that control modules for every driving assistance function are controlled by a control unit 140 of the vehicle driving assistance device 100.

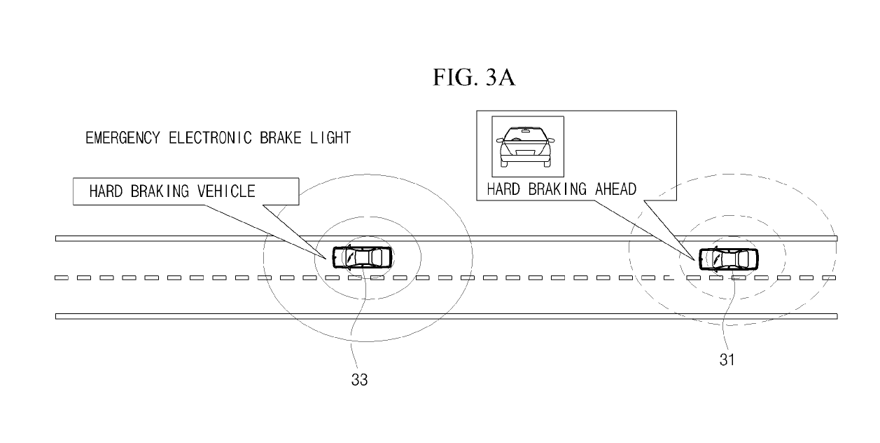

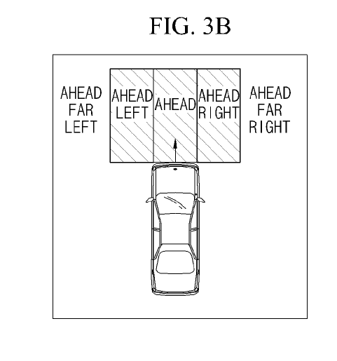

Hereinafter, examples of the plurality of driving assistance functions will be briefly described with reference to FIGS. 3 to 9.

FIGS. 3A and 3B are a view illustrating an emergency electronic brake light function among a plurality of driving assistance functions which is implemented in a vehicle according to an exemplary embodiment of the present invention. Here, the emergency electronic brake light function is an emergency electronic brake light system which warns sudden stop of a host vehicle 31 and another vehicle 33.

For example, as illustrated in FIG. 3A, when another vehicle 33 which is being driven in a lane next to the host vehicle 31, which is also being driven, suddenly stops, the other vehicle 33 transmits hard braking information to surrounding vehicles of the other vehicle 33 through the WAVE communication.

The emergency electronic brake light system of the host vehicle 31 next to the other vehicle 33 receives the hard braking information which is transmitted from the other vehicle 33 and determines accident possibility against the host vehicle 31. As a result of the determination, when there is an accident possibility, the emergency electronic brake light system displays a warning screen as illustrated in FIG. 3B to give a warning to the driver of the host vehicle 31.

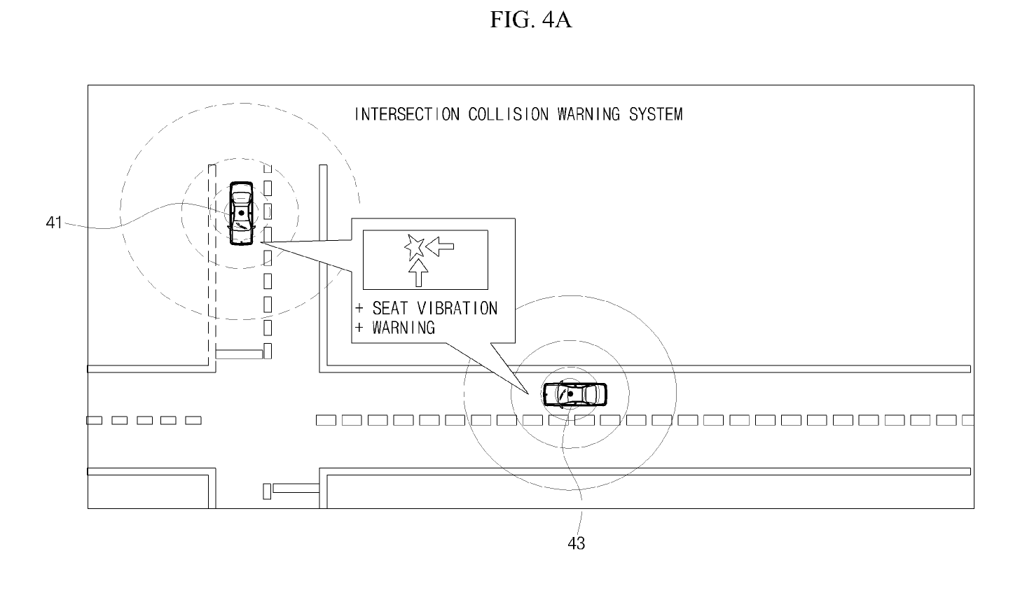

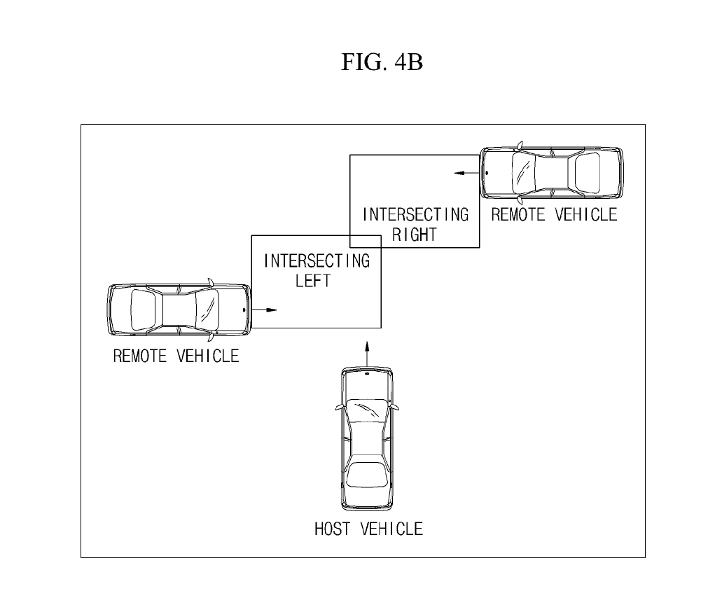

FIGS. 4A and 4B are a view illustrating an intersection collision prevention warning function among a plurality of driving assistance functions which is implemented in a vehicle according to an exemplary embodiment of the present invention. The intersection collision prevention warning function is an intersection collision warning system which determines and warns an accidence possibility when the host vehicle 41 enters an intersection.

For example, as illustrated in FIG. 4A, the intersection collision warning system of the host vehicle 41 determines whether side collision with another vehicle 43 (with perpendicular vehicles) which approaches the host vehicle from a side is predicted after a predetermined time when the host vehicle 41 approaches the intersection. As a result of the determination, when the collision is predicted, the intersection collision warning system accelerates or decelerates the host vehicle 41 to prevent the accident and as illustrated in FIG. 4B, gives guidance or a warning to the driver.

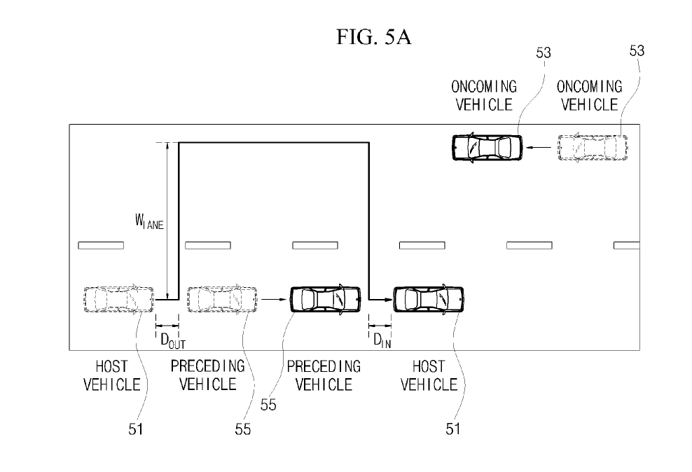

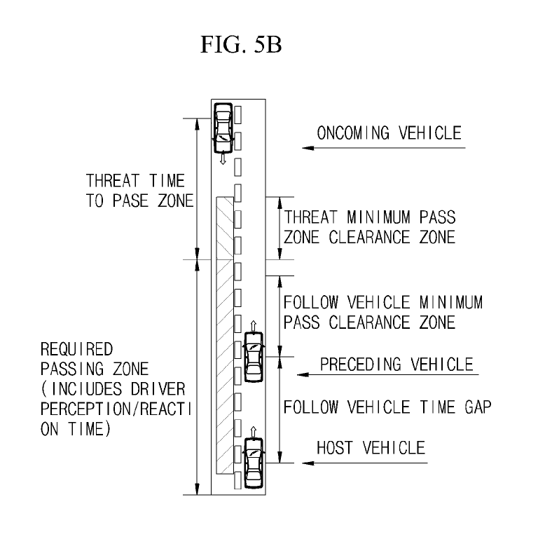

FIGS. 5A and 5B are a view illustrating an overtaking warning function among a plurality of driving assistance functions which is implemented in a vehicle according to an exemplary embodiment of the present invention. The overtaking warning function is a do-not-pass-warning system which determines and warns a danger of accident when a host vehicle 51 tries to pass another vehicle. For example, as illustrated in FIG. 5A, when the host vehicle 51 tries to pass the other vehicle in a passing zone, the do-not-pass warning system determines whether head-on collision with an oncoming vehicle 53 which approaches from an opposite direction is predicted or a sufficient distance to pass the oncoming vehicle is secured.

As a result of determination, when there is an accident possibility, the do-not-pass warning system gives a warning to the driver of the host vehicle 51 by outputting a screen as illustrated in FIG. 5B.

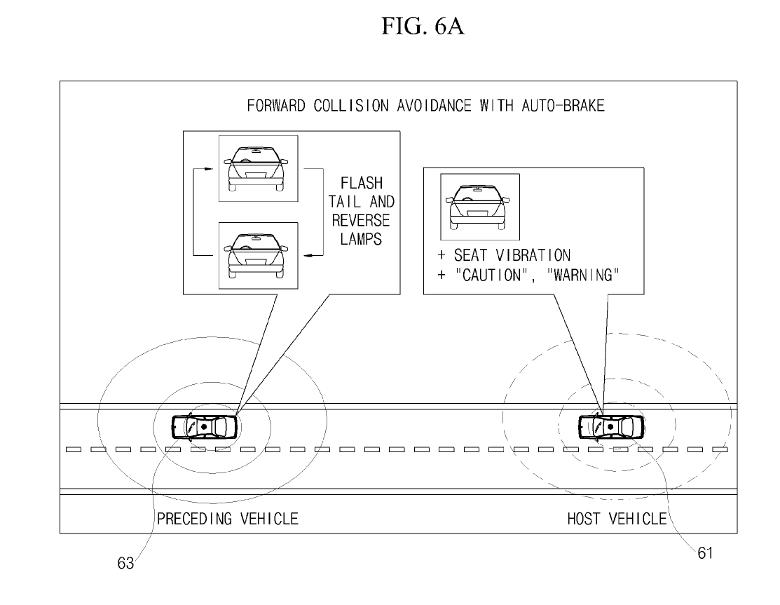

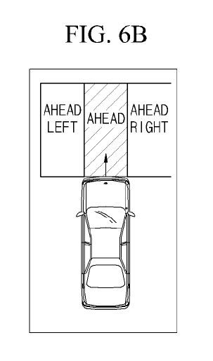

FIGS. 6A and 6B are a view illustrating a forward collision warning function among a plurality of driving assistance functions which is implemented in a vehicle according to an exemplary embodiment of the present invention. Here, the forward collision warning function is a forward collision warning system which determines and warns a danger of collision with another vehicle 63 in front of a host vehicle 61. For example, when the host vehicle 61 which is being driven at the rear side as illustrated in FIG. 6A at a current speed, the forward collision warning system determines whether the collision with the preceding vehicle 63 which is being driven in the same lane is predicted after a predetermined time. As a result of the determination, when the collision with the preceding vehicle 63 is predicted after the predetermined time, the forward collision warning system gives a warning to the driver of the host vehicle 61 by outputting a screen as illustrated in FIG. 6B.

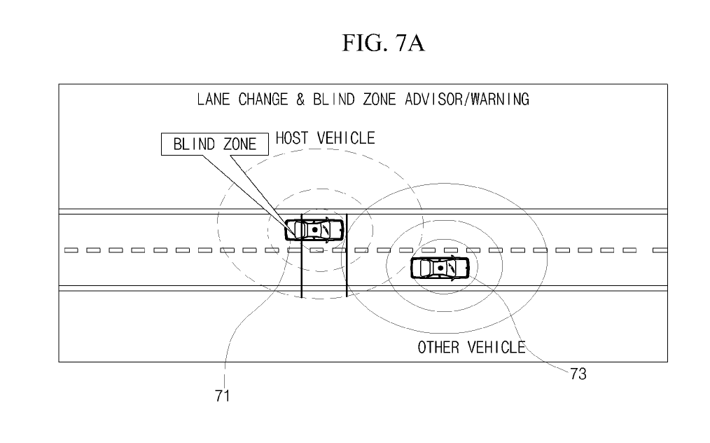

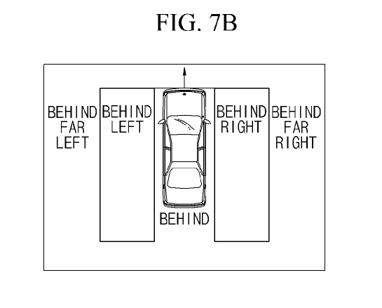

FIGS. 7A and 7B are a view illustrating a blind zone and lane change warning function among a plurality of driving assistance functions which is implemented in a vehicle according to an exemplary embodiment of the present invention. Here, the blind zone and lane change warning function is a blind zone and lane change warning system which determines and warns a danger of collision with an obstacle and the other vehicle 73 which are located in a blind zone when a host vehicle 71 tries to change a lane. For example, the blind zone and lane change warning system determines whether there is the other vehicle 73 or an obstacle in the adjacent lane or the blind zone when the host vehicle 71 tries to change the lane on which the host vehicle 71 is being driven as illustrated in FIG. 7A. As a result of the determination, when there is the other vehicle 73 or the obstacle in the adjacent lane or the blind zone, the blind zone and lane change warning system gives a warning to the driver of the host vehicle 71 by outputting a screen as illustrated in FIG. 7 B.

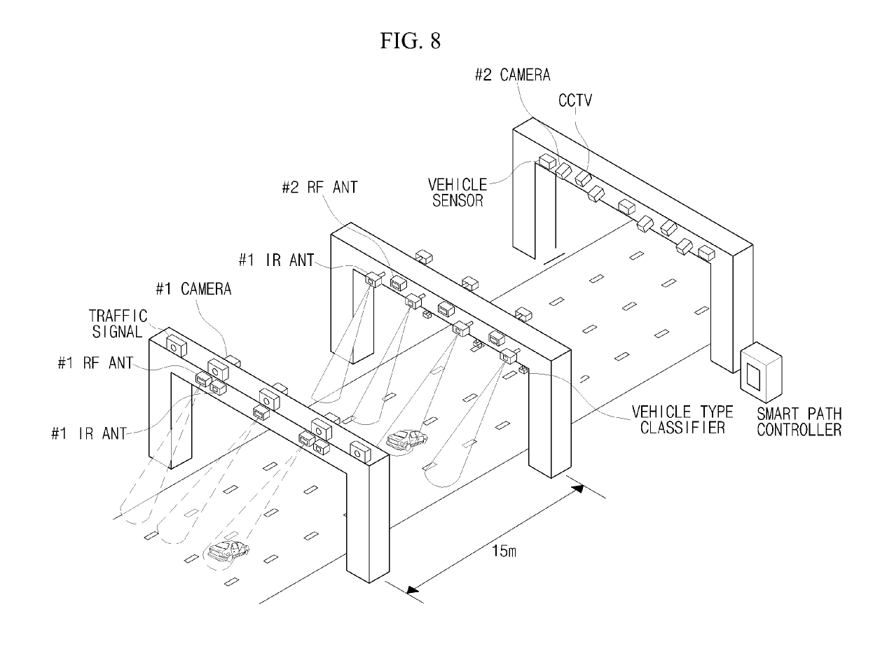

FIG. 8 is a view illustrating a smart tolling service function among a plurality of driving assistance functions which is implemented in a vehicle according to an exemplary embodiment of the present invention. Here, the smart tolling function is a smart tolling service which allows a driver to automatically pay a toll of a toll road such as a highway. For example, according to a high-pass system which is currently used in Korea, a toll station which collects highway toll is provided. However, the smart tolling service provides a service which does not provide an obstacle such as a toll station and allows the driver to pay tolls without stopping or decelerating the vehicle which is being driven as illustrated in FIG. 8.

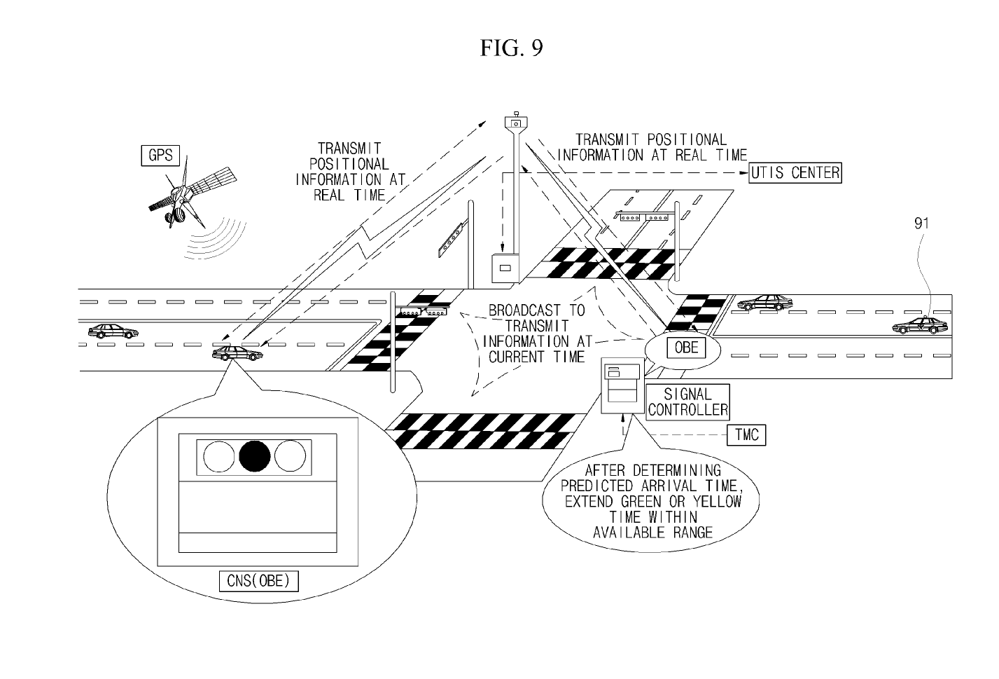

FIG. 9 is a view illustrating an emergency vehicle signal preemption function among a plurality of driving assistance functions which is implemented in a vehicle according to an exemplary embodiment of the present invention. Here, the emergency vehicle signal preemption function is an emergency vehicle signal preemption system which controls a signal so as to allow an emergency vehicle to pass an intersection with a traffic signal without being delayed or congested. For example, as illustrated in FIG. 9, when an emergency vehicle 91 such as a fire truck, a police car, or an ambulance enters an intersection with a traffic signal, the emergency vehicle may smoothly pass through the intersection without being delayed or congested. In this case, according to the emergency vehicle signal preemption system, the emergency vehicle 91 transmits positional information of its own vehicle (emergency vehicle 91) to a signal controller of the intersection with a traffic signal through the WAVE communication, before entering the intersection with a traffic signal. Therefore, the emergency vehicle signal preemption system predicts a time when the emergency vehicle 91 will enter the intersection and controls a traffic signal such that when a signal is a green light, the green light is continuously displayed and when the signal is a red light, the signal is changed into green light so as to allow the emergency vehicle 91 to pass the intersection. Further, the emergency vehicle signal preemption system gives guidance indicating that the other vehicle 93 which enters the intersection cannot pass the intersection due to entrance of the emergency vehicle 91, by outputting to the screen.

The vehicle driving assistance device 100 includes a collecting unit 110, a determining unit 120, a storing unit 130, and a control unit 140, as illustrated in FIG. 1, in order to selectively activate the plurality of driving assistance function which is implemented in a vehicle in accordance with a kind of road as described above.

The collecting unit 110 collects vehicle (host vehicle) safety information including positional information of the vehicle (host vehicle). For example, the collecting unit 110 may collect positional information (position coordinate data) of a vehicle at real-time through at least one module (desirably, all GPS/GNSS modules) of a global positioning system (GPS) module and a global navigation satellite system (GNSS) module of a navigation system which are implemented in the vehicle. Further, the collecting unit 110 may further collect driving direction information (a value of a heading angle indicating an angle direction of the host vehicle at which the host vehicle proceeds when a reference point is 0°) of a vehicle (the host vehicle) through the positional information.

The vehicle safety information which is collected by the collecting unit 110 includes state information of the vehicle. For example, the collecting unit 110 may collect the state information of the host vehicle which is obtained at the time when the vehicle is being driven, such as speed information, steering information, brake information, steering light manipulation information of the vehicle from a body control module (BCM) or an electronic control unit (ECU) of the vehicle at real time.

The collecting unit 110 may further collect traffic information and other vehicle state information from an external server or other vehicle.

For example, the collecting unit 110 may collect traffic information from the external server. The collecting unit 110 may collect traffic information such as traffic signal information, road section speed, delay information, and accident information from an infrastructure (external server) through vehicle to infrastructure (V2I) communication at real time.

As another example, the collecting unit 110 may collect safety information of the other vehicle from the other vehicle. The collecting unit 110 may collect the state information of the other vehicle which is obtained when the other vehicle being driven, such as speed information, brake information, or steering light manipulation information of the other vehicle from the other vehicle, which is being driven near the vehicle (host vehicle), through vehicle to vehicle (V2V) communication at real time.

In the meantime, the vehicle safety information which is collected by the collecting unit 110 may be broadcasted to the infrastructure and the other vehicle which is being driven near the vehicle through a separate communication module. Here, the communication module may be a WAVE data handler which supports the V2I communication or the V2V communication based on a wireless access in vehicular infrastructure (WAVE).

For example, the information which is collected by the collecting unit 110 may be transmitted at a predetermined interval (for example, 100 ms) without separately processing the information. As another example, the information which is collected by the collecting unit 110 may be processed by a separate control module or a control module (for example, the control unit 140) which controls a plurality of driving assistance functions and the processed information may be transmitted through a communication module. For example, the speed information and the positional information of the vehicle are processed (calculated) by a separate module (for example, a path prediction module) after a predetermined time (for example, 10 seconds) so as to indicate where the vehicle is located and is driven. And then the processed information may be transmitted to the infrastructure (infra) and the other vehicle through the communication module. In this case, the transmitted information may be included in a basic safety message (BSM) which is generated by a WAVE message generating module and the generated BSM may be transmitted to the infrastructure and the other vehicle through the WAVE data handler.

The determining unit 120 is a configuration which determines a kind of road on which the vehicle is being driven. For example, the determining unit 120 determines a position where the vehicle is being driven and the kind of road on which the vehicle is driven using the positional information of the vehicle (host vehicle) which is collected by the collecting unit 110 and map information which has been already stored.

Here, the map information which has been already stored is map information which is used for a navigation system of a vehicle and may include road type information for every road. The kind of road may be classified into a highway, a general road, a national highway, an intersection with a traffic signal, an intersection without having a traffic signal, two way stop, three way stop, and a tunnel using road characteristic information such as the number of lanes, whether to allow passing, speed limit, a gradient, a radius of curvature, a traffic signal, a high-pass section, to be set in advance.

Alternatively, the determining unit 120 may confirm a driving road on which the vehicle is driven a predetermined time later (for example, one minute later) using the positional information and the speed information of the vehicle which is collected by the collecting unit 110.

The storing unit 130 is a memory in which data is stored, and may be a flash memory. For example, driving assistance function information which is activated for every type of road is stored in the storing unit 130. In this case, the driving assistance functions which are activated in accordance with the kind of road may be grouped to be stored in the storing unit 130. The driving assistance functions which are activated in accordance with the kind of road may be as follows.

When the kind of road is a highway, among the plurality of driving assistance functions, the emergency electronic brake light function, the forward collision warning function, the blind zone and lane change warning function, and the smart tolling function are grouped as activated groups to be stored in the storing unit 130 as driving assistance functions which are activated on the highway.

The emergency electronic brake light function, the forward collision warning function, and the blind zone and lane change warning function for the general road (downtown and local), the emergency electronic brake light function, the forward collision warning function, and the blind zone and lane change warning function for the national highway, and the intersection collision warning function, and the emergency vehicle signal preemption function for the intersection with a traffic signal are grouped as activated groups on the general road to be stored in the storing unit 130. The intersection collision warning function for the intersection without having a traffic signal and the intersection collision warning function for two-way and four-way stop are stored in the storing unit 130 as the driving assistance function which is activated at the intersection without having a traffic signal.

As described above, the driving assistance function which is activated in accordance with the kind of road may be set in advance by a manager (a developer) to be stored in the storing unit 130. Further, the driving assistance function which is activated in accordance with the kind of road may be added or deleted by the driver or the manager.

The control unit 140 is a configuration which controls overall operation of the vehicle driving assistance device 100 and controls the plurality of driving assistance functions to be activated or inactivated to assist the driving of the vehicle. Further, the control unit 140 may control module operations of the plurality of driving assistance functions.

The control unit 140 reads information of the storing unit 130 in accordance with the kind of driving road which is determined by the determining unit 120 to activate at least one of the plurality of driving assistance functions. For example, the control unit 140 reads the driving assistance function information which is grouped as an activating group in accordance with the kind of driving road of the host vehicle which is determined by the determining unit 120, from the storing unit 130. The control unit 140 activates the driving assistance function which is read to be in a stand-by state. Further, the control unit 140 inactivates other functions than the driving assistance function which is grouped as an activated group in accordance with the kind of road. That is, the control unit 140 operates a control module of the driving assistance function which is activated in accordance with the kind of driving road on which the host vehicle is being driven.

For example, when the determining unit 120 determines the driving road on which the vehicle is being driven as a highway, the control unit 140 activates the emergency electronic brake light function, the forward collision warning function, the blind zone and lane change warning function, and the smart tolling function among the plurality of driving assistance functions and inactivates other functions to be off. Thereafter, when the determining unit 120 determines that the vehicle moves by driving to be out off the highway and enter the general road, the control unit 140 maintains an activated state of the emergency electronic brake light function, the forward collision warning function, and the blind zone and lane change warning function, and inactivates other functions such as the smart tolling function.

The control unit 140 may determine the kind of driving road on which the vehicle will drive a predetermined time later from the determining unit 120 to activate or inactivate the plurality of driving assistance function.

In the meantime, the control unit 140 controls the control module of an activated driving assistance function to perform the driving assistance operation while the vehicle is being driven. For example, when the plurality of driving assistance functions is activated, control modules of the plurality of driving assistance functions perform their own logic at real time. In this case, the plurality of control modules (each control module for the plurality of driving assistance functions) may perform a logic (operation) using the vehicle information which is collected by the collecting unit 110. For example, the operation of outputting warning information or guidance information may be performed depending on whether an event (danger event or guidance event) occurs in each control module of the plurality of driving assistance functions.

As an example, a control module which performs a driving assistance function for a warning determines whether to satisfy a danger condition (whether a danger event occurs), which is set in advance, using information collected by the collecting unit 110 while the vehicle is being driven at real time. When the danger condition is satisfied as a result of the determination, the control module which performs the driving assistance function for a warning performs an operation which outputs warning information.

As another example, a control module which performs a driving assistance function for guidance determines whether a guidance event occurs, using information collected by the collecting unit 110 while the vehicle is driven at real time. When the guidance event occurs as a result of the determination, the control module which performs the driving assistance function for guidance performs an operation which outputs guidance information.

The control unit 140 outputs warning information or guidance information of each control module which performs the driving assistance function to provide the information to the driver. In this case, the control unit 140 may provide information to the driver through a user interface. As an example, when the control module of the driving assistance function related to warning performs the driving assistance function operation to output warning information, the control unit 140 outputs a warning sound through a speaker in the vehicle to warn the driver. As another example, when the control module of the driving assistance function related with guidance performs the driving assistance function operation to output guidance information, the control unit 140 outputs a vocal warning through a speaker in the vehicle to provide guidance information to the driver.

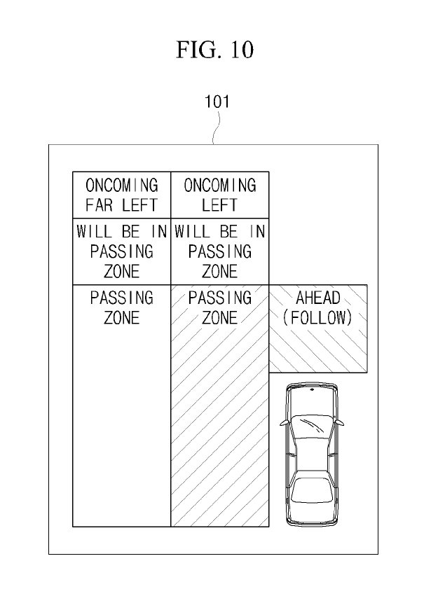

For example, the control unit 140 may provide the warning information or the guidance information to the driver through the screen output 101 as illustrated in FIG. 10. In this case, the control unit 140 may use different displayed colors in accordance with a warning level to provide information to the driver. For example, the control unit 140 displays a safe state with green, a warning state with yellow, and a dangerous state with red.

In the meantime, events (a danger event or a guidance event) may simultaneously occur in two or more driving assistance functions in the state where the plurality of driving assistance functions (at least two driving assistance functions) is activated. As described above, when the information (warning information or guidance information) in the control modules of two or more driving assistance functions needs to be output, the control unit 140 may output information of one driving assistance function in consideration of a priority which is set in advance.

For example, among the driving assistance functions, a driving assistance function which performs a warning operation may have higher priority than a driving assistance function which performs a guidance operation. That is, when both the warning information and the guidance information need to be output, the control unit 140 may output the warning information. Further, a priority of the plurality of driving assistance functions which performs the warning operation may be set in advance in consideration of an accident generating possibility. That is, among the plurality of driving assistance functions, a driving assistance function which most significantly affects the safety of the driver (which has a high accident generating possibility) may have relatively high priority.

As described above, according to an exemplary embodiment of the present invention, driving assistance functions which are activated in accordance with a kind of road are classified in advance to activate some of the driving assistance functions in accordance with the kind of road on which the vehicle is being driven and inactivate other functions so that a load (computing and sensing loads) for vehicle driving assistance may be reduced as compared with the vehicle driving assistance technology of the related art which drives all the plurality of driving assistance functions which is implemented in the vehicle and an appropriate function at a right time or right place is operated to reduce an error.

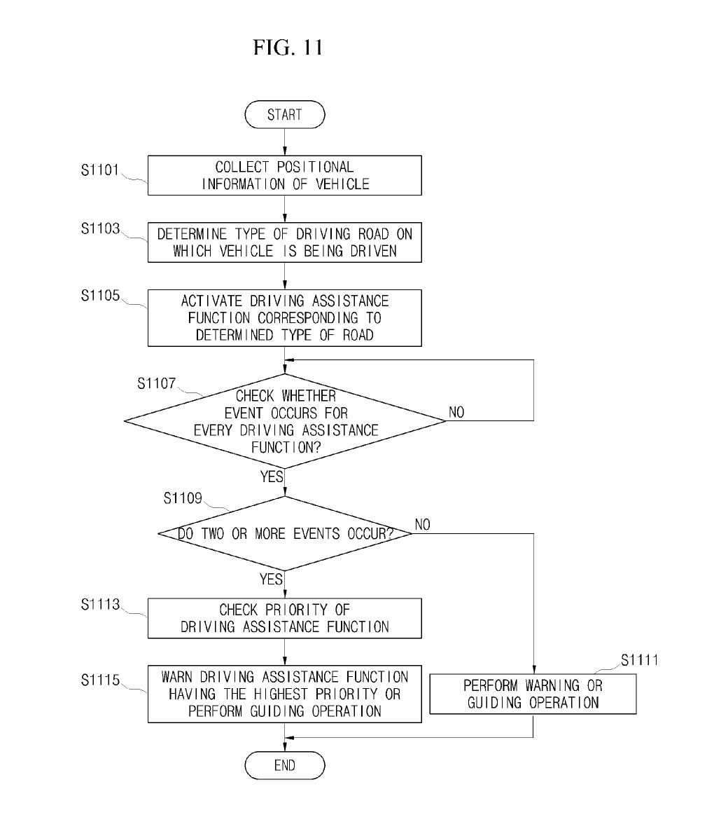

FIG. 11 is a flowchart of an automatic activating method of a vehicle driving assistance function by a vehicle driving assistance device according to an exemplary embodiment of the present invention.

In step S1101, a vehicle driving assistance device 100 collects positional information of a vehicle (host vehicle). For example, the vehicle driving assistance device 100 may collect positional information (position coordinate data) of a vehicle through at least one module (desirably, all GPS/GNSS modules) of a GPS module and a GNSS module of a navigation system which are implemented in the vehicle at real time.

The vehicle driving assistance device 100 may further collect safety information of the host vehicle from a body control module of a vehicle, traffic information from an infrastructure through vehicle to infrastructure (V2I) communication, and safety information of the other vehicle from the other vehicle which is located near the vehicle through the vehicle to vehicle (V2V) communication.

In step S1103, the vehicle driving assistance device 100 determines a kind of driving road on which the vehicle is driven.

For example, the vehicle driving assistance device 100 determines a location where the vehicle is currently driving and a kind of driving road on which the vehicle is driven using the positional information collected in step S100 and map information which has been already stored.

Here, the map information which has been already stored is map information which is used for a navigation system of a vehicle and may include road type information for every road. The kind of road may be classified into a highway, a general road, a national highway, an intersection with a traffic signal, an intersection without having a traffic signal, two-way stop, three-way stop, and a tunnel using road characteristic information such as the number of lanes, whether to allow passing, speed limit, a gradient, a radius of curvature, a traffic signal, and a high-pass section, to be set in advance.

In step S1105, the vehicle driving assistance device 100 activates a driving assistance function in accordance with the kind of road.

For example, the vehicle driving assistance device 100 reads the information which is grouped as a driving assistance function which is activated in accordance with the kind of driving road of the vehicle which is determined in step S200, from a memory to activate the driving assistance function to be in a standby state. Further, the vehicle driving assistance device 100 inactivate functions other than the driving assistance function.

In step S1107, the vehicle driving assistance device 100 checks whether an event for every activated driving assistance function occurs. For example, the vehicle driving assistance device 100 controls a control module of the driving assistance function which is activated while the vehicle is being driven to perform the driving assistance operation. In this case, the control module of the activated driving assistance function may check whether the event occurs using the vehicle safety information, traffic information, and safety information of the other vehicle which are collected in step S100.

As a checking result in step S1107, when an event occurs, in step S1109, the vehicle driving assistance device 100 checks whether an event occurs in two or more driving assistance functions.

As a checking result in step S1109, when an event occurs in one driving assistance function, the vehicle driving assistance device 100 outputs at least one information of warning information and guidance information in accordance with the driving assistance function corresponding to the occurring event in step S1111. In this case, the vehicle driving assistance device 100 outputs a warning sound or a guidance message through a speaker and outputs a warning screen or a guidance screen through a display.

As an example, in the case of the driving assistance function for warning, a control module of a driving assistance function determines whether to satisfy a predetermined danger condition (whether a danger event occurs) using information which is collected while the vehicle is being driven at real time. As a result of the determination in the control module of the driving assistance function for warning, when the danger condition is satisfied so that the warning event occurs, the vehicle driving assistance device 100 performs an operation to output warning information.

As another example, in the case of the driving assistance function for guidance, a control module of a driving assistance function determines whether a guidance event occurs using information which is collected while the vehicle is being driven at real time. As a result of the determination in the control module of the driving assistance function for guidance, when the warning event occurs, the vehicle driving assistance device 100 performs an operation to output guidance information.

As a result of checking in step S1109, when events simultaneously occur in two or more driving assistance functions, the vehicle driving assistance device 100 checks predetermined priority of the driving assistance functions in which event occurs in step S1113.

For example, among the driving assistance functions, a driving assistance function which performs a warning operation may have a higher priority than a driving assistance function which performs a guidance operation. Further, a priority of the plurality of driving assistance functions which performs the warning operation may be set in advance in consideration of an accident generating possibility. That is, among the plurality of driving assistance functions, a driving assistance function which most significantly affects the safety of the driver (which has a high accident generating possibility) may have a relatively high priority.

In accordance with the checking result in step S1113, the vehicle driving assistance device 100 outputs at least one information of the warning information and the guidance information corresponding to the driving assistance function having the highest priority in step S1115.

As described above, according to an exemplary embodiment of the present invention, driving assistance functions which are activated in accordance with a kind of road are classified in advance to activate some of the driving assistance functions in accordance with the kind of road on which the vehicle is driven and inactivate other functions so that a load (computing and sensing loads) for vehicle driving assistance may be reduced as compared with the vehicle driving assistance technology of the related art which drives all the plurality of driving assistance functions which is implemented in the vehicle and an appropriate function at a right time or right place is operated to reduce an error.

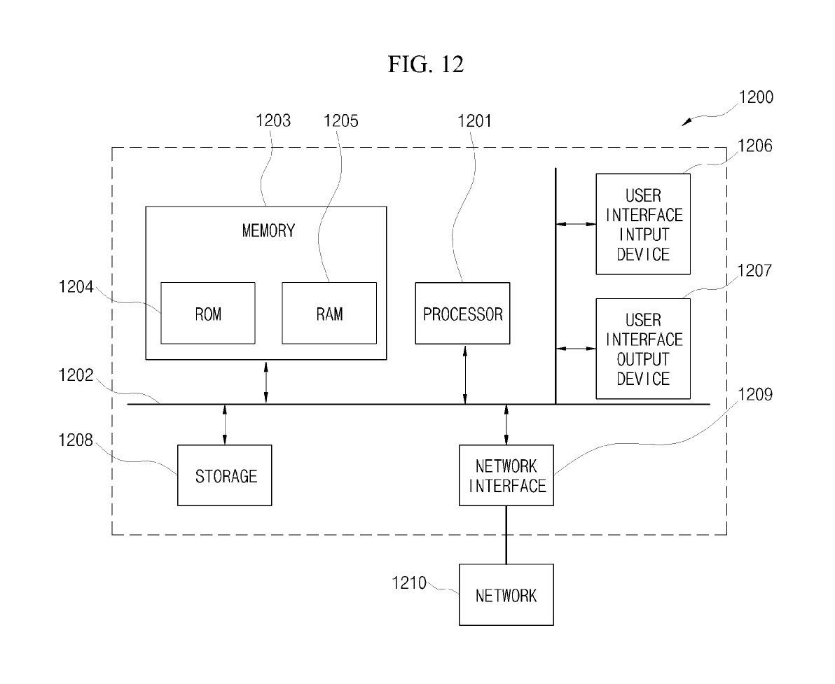

An embodiment of the present invention may be implemented in a computer system, e.g., as a computer readable medium. As shown in in FIG. 12, a computer system 1200 may include one or more of a processor 1201, a memory 1203, a user input device 1206, a user output device 1207, and a storage 1208, each of which communicates through a bus 1202. The computer system 1200 may also include a network interface 1209 that is coupled to a network 1210. The processor 1201 may be a central processing unit (CPU) or a semiconductor device that executes processing instructions stored in the memory 1203 and/or the storage 1208. The memory 1203 and the storage 1208 may include various forms of volatile or non-volatile storage media. For example, the memory may include a read-only memory (ROM) 1204 and a random access memory (RAM) 1205.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The configuration of the present invention has been described in detail with reference to the exemplary embodiment of the present invention, but those skilled in the art will understand that the present invention may be implemented in other specific forms without changing the technical spirit or an essential feature thereof. Thus, it is to be appreciated that embodiments described above are intended to be illustrative in every sense, and not restrictive. The scope of the present invention is represented by the claims to be described below rather than the detailed description, and it is to be interpreted that the meaning and scope of the claims and all the changes or modified forms derived from the equivalents thereof come within the scope of the present invention.

What is claimed is:

1. A vehicle driving assistance device, comprising:
a collecting unit which collects vehicle safety information including positional information of a vehicle;
a determining unit which determines a kind of driving road on which the vehicle is being driven using the positional information; and
a control unit which activates a driving assistance function related with the kind of driving road, among a plurality of driving assistance functions which is implemented in the vehicle.

2. The device of claim 1, further comprising:
a storing unit in which driving assistance functions which are grouped for every type of roads are stored, among the plurality of driving assistance functions,
wherein the control unit activates a driving assistance function corresponding to the kind of driving road, among the plurality of driving assistance functions and inactivates other driving assistance functions using the grouped driving assistance functions.

3. The device of claim 1, wherein the control unit checks whether an event occurs by a control module of the activated driving assistance function and when the event occurs as a checking result, outputs event information of the driving assistance function in which the event occurs.

4. The device of claim 3, wherein the collecting unit further collects traffic information from an infrastructure through vehicle to infrastructure (V2I) communication and
a control module of the activated driving assistance function checks whether a danger event or a guidance event occurs using the vehicle safety information and the traffic information which are collected by the collecting unit.

5. The device of claim 3, wherein the collecting unit further collects other vehicle safety information of the other vehicle which is located near the vehicle through vehicle to vehicle (V2V) communication and
a control module of the activated driving assistance function checks whether a danger event or a guidance event occurs, using the vehicle safety information and the other vehicle safety information which are collected by the collecting unit.

6. The device of claim 3, wherein in a state where at least two driving assistance functions are activated among the plurality of driving assistance functions, when events simultaneously occur in the control modules of two or more driving assistance functions, the control unit outputs event information of the driving assistance function in which an event having the highest priority occurs in consideration of a priority which is set in advance.

7. The device of claim 3, wherein the control unit includes an automatic activating function which performs an operation of outputting at least one information of the warning information and the guidance information depending on whether the occurring event is a danger event or a guidance event.

8. The device of claim 1, wherein the plurality of driving assistance functions includes an emergency electronic brake light function, an intersection collision warning function, an overtaking warning function, a forward collision warning function, a blind zone and lane change warning function, a smart tolling service function, and an emergency vehicle signal preemption function.

9. The device of claim 1, wherein the collecting unit collects positional information of the vehicle through at least one of a GPS module and a GNSS module and collects state information of the host vehicle including speed information, steering information, brake information, and steering light manipulation information of the vehicle from a body control module (BCM) and an electronic control unit (ECU) of the vehicle.

10. An automatic activating method of a vehicle driving assistance function by a vehicle driving assistance device, the method comprising:
collecting vehicle safety information including positional information of a vehicle;
determining a kind of driving road on which the vehicle is being driven using the collected positional information; and
activating a driving assistance function related with the determined type of driving road, among a plurality of driving assistance functions which is implemented in the vehicle.

11. The method of claim 10, wherein the activating: includes activating a driving assistance function corresponding to the kind of driving road and inactivating other driving assistance functions, by reading the grouped driving assistance function from a memory in which driving assistance functions which are grouped for every type of road among the plurality of driving assistance functions are stored.

12. The method of claim 10, further comprising:
checking whether an event occurs in a control module of the activated driving assistance function; and
outputting event information of a driving assistance function in which the event occurs when the event occurs as a checking result.

13. The method of claim 12, wherein the outputting includes outputting at least one information of the warning information and the guidance information depending on whether the occurring event is a danger event or a guidance event.

14. The method of claim 12, wherein in a state where at least two driving assistance functions are activated among the plurality of driving assistance functions, when two or more events simultaneously occur, the outputting includes outputting information of the driving assistance function in which an event having the highest priority occurs in consideration of a priority which is set in advance.

15. The method of claim 12, wherein the control module of the activated driving assistance function checks whether an event occurs using at least one of safety information of the host vehicle which is collected from the body control module of the vehicle, traffic information collected from an infrastructure through vehicle to infrastructure (V2I) communication, and other vehicle safety information which is collected from other vehicle which is located near the vehicle through vehicle to vehicle (V2V) communication.
